(19) United States
(12) Patent Application Publication
(10) Pub. No.: US 2018/0100225 A1
(43) Pub. Date: Apr. 12, 2018

(54) THERMAL SPRAYING METHOD

(71) Applicant: KS HUAYU ALUTECH GMBH, NECKARSULM (DE)

(72) Inventors: CHRISTIAN KLIMESCH, KARLSRUHE (DE); ANDREAS SCHALLER, BILLIGHEIM (DE); LEANDER SCHRAMM, REMDA-TEICHEL OT TEICHROEDA (DE); DIETER GEBERT, OEHRINGEN-VERRENBERG (DE)

(73) Assignee: KS HUAYU ALUTECH GMBH, NECKARSULM (DE)

(21) Appl. No.: 15/736,778

(22) PCT Filed: May 13, 2016
(86) PCT No.: PCT/EP2016/060881

§ 371 Date: Dec. 15, 2017

(30) Foreign Application Priority Data
Jun. 19, 2015 (DE) 10 2015 109 874.1

(51) Int. Cl. C23C 4/18; C23C 4/134; C23C 4/131; F02F 1/00; G01N 21/84; G01N 21/954; B05B 13/06

(52) U.S. Cl. CPC C23C 4/18; C23C 4/134; C23C 4/131; F02F 1/004; G01N 2021/9548; G01N 21/954; B05B 13/06; G01N 2021/8427; G01N 21/8422

(57) ABSTRACT

A thermal spraying method for coating an inner surface of a cylinder of an internal combustion engine or of a piston engine. The method includes applying a thermal spray layer onto the inner surface of the cylinder so as to obtain a coated inner surface, inserting an optical sensor device into the cylinder, and scanning the coated inner surface via the optical sensor device in order to detect at least one of a ridge and an indentation in the thermal spray layer. A thermal spray torch for the method includes an optical sensor device which is inserted into the cylinder and to scan the coated inner surface of the cylinder so as to detect at least one of a ridge and an indentation in the coated inner surface.

### CROSS REFERENCE TO PRIOR APPLICATIONS

This application is a U.S. National Phase application under 35 U.S.C. § 371 of International Application No. PCT/EP2016/060881, filed on May 13, 2016 and which claims benefit to German Patent Application No. 10 2015 109 874.1, filed on Jun. 19, 2015. The International Application was published in German on Dec. 22, 2016 as WO 2016/202512 A1 under PCT Article 21(2).

### FIELD

The present invention relates to a thermal spraying method for coating the inner surface of a cylinder of an internal combustion engine or a piston engine.

### BACKGROUND

Thermal spray torches have previously been described and are used for coating surfaces. For example, the PTWA (Plasma Transferred Wire Arc Spraying) or the RSW (Rotating Single Wire) methods are used in the automobile industry to coat the running surfaces of cylinder bores in internal combustion engines. For this purpose, a wire is fed to the spray torch by a feed device, the particles of the wire being sprayed onto the inner surface of the cylinders in a gas flow.

It is necessary to control the results of the method for achieving a consistent quality of the coating process. This is in particular the case since a subsequent honing process is very sensitive to irregularities that may be formed by the thermal coating process for a cylinder of an internal combustion engine or a piston engine. It is thus important to recognize a defective part and to rework the part if necessary.

The quality of the thermal spraying process has to date been controlled by a worker visually inspecting the coated cylinder running surface.

### SUMMARY

An aspect of the present invention is to provide a thermal spraying method and a device for coating the inner surface of a cylinder of an internal combustion engine or a piston engine which allows for a simpler check of the result of the coating process.

In an embodiment, the present invention provides a thermal spraying method for coating an inner surface of a cylinder of an internal combustion engine or of a piston engine. The method includes applying a thermal spray layer onto the inner surface of the cylinder so as to obtain a coated inner surface, inserting an optical sensor device into the cylinder, and scanning the coated inner surface via the optical sensor device in order to detect at least one of a ridge and an indentation in the thermal spray layer. In an embodiment, the present invention also provides a thermal spray torch for applying a thermal spray layer onto an inner surface of a cylinder of an internal combustion engine or of a piston engine so as to obtain a coated inner surface. The thermal spray torch includes an optical sensor device configured to be inserted into the cylinder and to scan the coated inner surface of the cylinder so as to detect at least one of a ridge and an indentation in the coated inner surface.

### BRIEF DESCRIPTION OF THE DRAWING

The present invention is described in greater detail below on the basis of embodiments and of the drawing in which:

FIG. 1 shows a cylinder on whose inner surface a thermal spray layer was applied via a PTWA process.

### DETAILED DESCRIPTION

The thermal spraying method for coating the inner surface of a cylinder of an internal combustion engine or piston engine comprises the following method steps:

A thermal spray layer is applied onto the inner surface of the cylinder. This may be effected, for example, using the PTWA/RSW method known from the prior art.

An optical sensor device is inserted into the coated cylinder. The optical sensor device can, for example, be introduced into the inner volume of the cylinder so that it is located axially between the base surfaces of the cylinder.

The coated inner surface of the cylinder is then scanned by the optical sensor device in order to detect ridges in the coating. Ridges may be formed during the coating process, for example, due to the wire supplied to the spray torch not being uniformly molten.

By using an optical sensor device as provided by the present invention, these ridges can be detected in an automated manner so that a control of the quality of the coating process by a human is no longer required. The defective part can then be reworked if necessary.

The optical sensor device can, for example, be a camera.

In an embodiment of the present invention, the optical sensor device can, for example, be a laser interferometer or a white light interferometer. As an alternative, a device working on a holographic basis may be used as the optical sensor device.

Such a device can, for example, be used to measure the distance from the axis of the sensor to the coated surface. For this purpose, the optical sensor device may, for example, be arranged at the center axis of the cylinder so that, in an ideal case, it should be at a constant distance to the entire coated inner surface of the cylinder. In case of a deviation of this distance from a set distance, which deviation exceeds a defined threshold, a ridge or an indentation is assumed to exist in the coating. A threshold may be defined, for example, by manufacturing specially fabricated defective cylinders whose defects are exactly at the still admissible limit. It is possible to define a defect threshold by measuring this defective sample part.

Different parameters of the least-square circle/cylinder may be considered, for example, the mean value.

In an embodiment of the present invention, the optical sensor device can, for example, detect the position, number and size of the ridges in the coating and evaluate these ridges using software algorithms in order to evaluate the quality of the coating process. Mathematical methods, such as the equalization calculus according to Gauss, may, for example, be used to analyze the scattering on the surface of the cylinder. If the light scattering exceeds a defined threshold, the coated part is assumed to be defective. The following parameters may, for example, be considered: standard deviations, variance, range or distribution. The magnitude of the still admissible deviation depends on how many ridges or indentations are still admissible for a certain application.

The present invention further relates to a thermal spray torch for applying a thermal spray layer on the inner surface of a cylinder of an internal combustion engine or piston engine. The thermal spray torch now described may comprise all features that have been described in the context of the method of the present invention, and vice versa. The spray torch comprises an optical sensor device adapted to be inserted into the coated cylinder. The optical sensor device is designed to scan the coated inner surface of the cylinder and to detect ridges or recesses in the coating.

The optical sensor device can, for example, be suited to determine the distance from the center axis of the cylinder to its coated inner surface.

The optical sensor device can, for example, be arranged at the center axis of the cylinder and can, for example, be rotatable about the center axis.

An embodiment of the present invention is explained below under reference to the drawing.

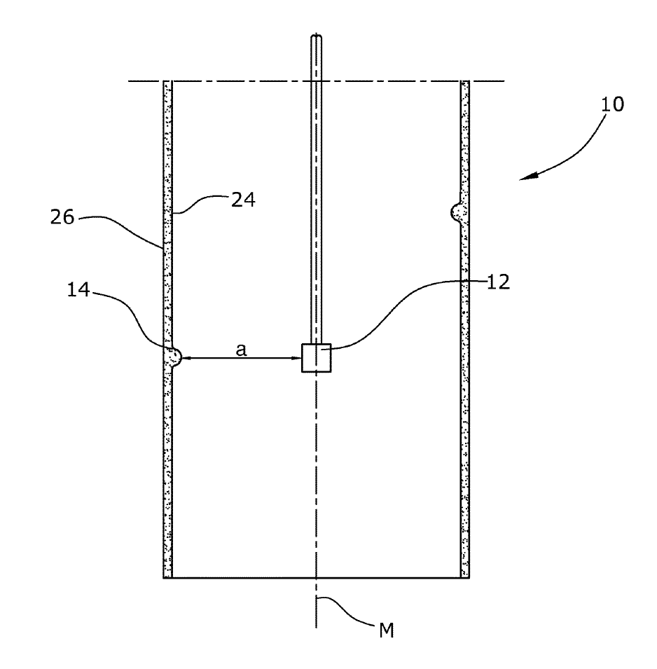

FIG. 1 shows a cylinder 10, on whose inner surface 26 a thermal spray layer 24 has been applied, for example, by a PTWA process. The thermal spray layer 24 shows a ridge 14 caused by an error in the coating process. The distance a from the center axis M of the cylinder 10 to the coated inner surface 24 of the cylinder 10 thus has a smaller value at the position of the ridge 14 than at the rest of the inner surface 26 of the cylinder 10. This deviation is detected by an optical sensor device 12 inserted into the cylinder 10, for example, a laser interferometer. The coating can thus be recognized as being defective and may be reworked if necessary.

The present invention is not limited to embodiments described herein; reference should be had to the appended claims.

What is claimed is:

1-8. (canceled)

9. A thermal spraying method for coating an inner surface of a cylinder of an internal combustion engine or of a piston engine, the method comprising:
applying a thermal spray layer onto the inner surface of the cylinder so as to obtain a coated inner surface;
inserting an optical sensor device into the cylinder; and
scanning the coated inner surface via the optical sensor device in order to detect at least one of a ridge and an indentation in the thermal spray layer.

10. The thermal spraying method as recited in claim 9, wherein the optical sensor device is a camera.

11. The thermal spraying method as recited in claim 9, wherein the optical sensor device is a laser interferometer.

12. The thermal spraying method as recited in claim 9, wherein,
the optical sensor device measures a distance from the a center axis of the cylinder to the coated inner surface, and
if a deviation of the distance from a set distance is deterimed and the deviation exceeds a defined threshold, at least one of a ridge and an indentation is assumed to exist in the coated inner surface.

13. The thermal spraying method as recited in claim 9, wherein the optical sensor device detects a position, a number and a size of the at least one of a ridge and an indentation in the coated inner surface and evaluates the at least one of a ridge and an indentation in the coated inner surface using software algorithms for evaluating a quality of a coating process.

14. A thermal spray torch for applying a thermal spray layer onto an inner surface of a cylinder of an internal combustion engine or of a piston engine so as to obtain a coated inner surface, the thermal spray torch comprising:
an optical sensor device configured to be inserted into the cylinder and to scan the coated inner surface of the cylinder so as to detect at least one of a ridge and an indentation in the coated inner surface.

15. The thermal spray torch as recited in claim 14, wherein the optical sensor device is further configured to determine a distance from a center axis of the cylinder to the coated inner surface.

16. The thermal spray torch as recited in claim 15, wherein the optical sensor device is arranged at the center axis.

17. The thermal spray toruch as recited in claim 16, wherein the optical sensor device is rotatable about the center axis.
